(19) United States
(12) Patent Application Publication
(10) Pub. No.: US 2014/0078281 A1
(43) Pub. Date: Mar. 20, 2014

(54) DROWSINESS WARNING DEVICE

(71) Applicant: UTECHZONE. CO., LTD., New Taipei City (TW)

(72) Inventors: CHIA-CHUN TSOU, NEW TAIPEI CITY (TW); PO-TSUNG LIN, NEW TAIPEI CITY (TW); CHIA-WE HSU, NEW TAIPEI CITY (TW)

(73) Assignee: UTECHZONE. CO., LTD., NEW TAIPEI CITY (TW)

(21) Appl. No.: 13/706,205

(22) Filed: Dec. 5, 2012

(30) Foreign Application Priority Data
Sep. 14, 2012 (TW) 101133733

(51) Int. Cl. G08B 21/06

(52) U.S. Cl. CPC G08B 21/06
USPC 348/78

(57) ABSTRACT

A drowsiness warning device includes a storage unit storing a drowsiness warning program, an image capturing unit, a processing unit and an output unit. The processing unit loads and processes the drowsiness warning program and the drowsiness warning program enables the processing unit to perform steps comprising: receiving a sequence of images captured by the image capturing unit; performing an image analyzing step to each of the images; performing a determining step based on results of the image analyzing step to determine if a driver is drowsy; and driving the output unit to create a warning message if the determining result shows that the driver is drowsy. The image analyzing step includes analyzing a degree of curvature of an upper eyelid in each of the images.

### BACKGROUND OF THE DISCLOSURE

1. Field of Invention

The invention relates to a drowsiness warning device utilizing an image processing technology, and more particularly, to a technology for determining if an eye closes or not by analyzing a degree of curvature of an upper eyelid in a sequence of images.

2. Related Art

Based on traffic security, various drowsiness warning devices have been developed and can determine if a driver is drowsy by detecting a state of the driver's eyes. When the driver is determined to be drowsy, an alarm can be set off to wake the driver up. Traditional drowsiness warning devices, such as those disclosed in Taiwan patent Nos. 436436, M416161, 1349214 and 201140511, China patent No. CN101196993 and so on, employed various technologies. These patent applications disclose determination if eye-blink frequency or eye-closure duration exceeds a threshold level. If the eye-blink frequency or eye-closure duration exceeds the threshold level, the driver will be determined to be drowsy and an alarm can be set off. An image capturing module is often utilized to shoot a driver's face for detection of a state of the driver's eyes and then captured images can be processed by a central processing unit (CPU). The key to process is that regions of eyes in the images are readily and accurately positioned and the eyes in the regions are detected so as to determine if the eyes open or close.

The patent No. CN101196993 discloses a traditional eye-detection device, which positions nostrils in a face image, sets an eye searching area based on the positions of the nostrils and thereby finds an upper eyelid and a lower eyelid in the eye searching area. Determination if the eye opens or closes is then performed based on pixels between the upper and lower eyelids. This method has disadvantages that determination if the eye opens or closes is performed only when the upper and lower eyelids are found. Thus, this method is time-consuming and warning the driver is postponed.

### SUMMARY OF THE DISCLOSURE

The present invention is directed to a drowsiness warning device determining if an eye opens or closes when only an upper eyelid is found in an image and then readily warning a drowsy driver.

In accordance with the present invention, the drowsiness warning device includes a storage unit storing a drowsiness warning program, an image capturing unit capturing a sequence of images of a driver's face, a processing unit and an output unit, wherein the processing unit is electrically connected to the image capturing unit, the storage unit and the output unit, wherein the processing unit loads and processes the drowsiness warning program, and then the drowsiness warning program enables the processing unit to perform steps comprising: receiving the images captured by the image capturing unit; performing an image analyzing step to each of the images, wherein the image analyzing step further includes steps of obtaining an eye image from an analyzed image, processing the eye image so as to obtain an upper-eyelid image, detecting a degree of curvature of the upper-eyelid image and creating an eye state data based on a result of said detecting step; performing a determining step to determine if the driver is drowsy based on the data of the eye state; and driving the output unit to create a warning message if the determining result shows that the driver is drowsy.

In accordance with the present invention, the step of said obtaining the eye image from the analyzed image, processed by the processing unit, further includes steps of obtaining a face image from the analyzed image; finding each central point of two nostrils in the face image; calculating a distance D between the central points of the two nostrils and determining a starting point A (x1, y1) at a middle point between the central points of the two nostrils; calculating a base point B (x2, y2) based on the distance D and the starting point A (x1, y1), wherein x2=x1+k1×D and y2=y1+k2×D, wherein k1=1.6˜1.8 and k2=1.6˜1.8; defining a rectangular frame in the face image based on the base point B (x2, y2), wherein the base point B (x2, y2) is at a central point of the rectangular frame having a horizontal width w1 between 30 and 50 pixels and a vertical width w2 between 15 and 29 pixels, wherein w1>w2; and obtaining the eye image from an enclosure of the rectangular frame. In an embodiment, k1=k2.

In accordance with the present invention, the step of said obtaining the eye image from the analyzed image, processed by the processing unit, further includes steps of obtaining a face image from the analyzed image; finding each central point of two nostrils in the face image; calculating a distance D between the central points of the two nostrils and determining a middle point between the central points of the two nostrils; determining a base point having a horizontal distance to the middle point and a vertical distance to the middle point, wherein the horizontal distance equals k1×D and the vertical distance equals k2×D, wherein k1=1.6˜1.8 and k2=1.6˜1.8; defining a rectangular frame in the face image, wherein the base point is at a central point of the rectangular frame having a vertical width and a horizontal width greater than the vertical width; and obtaining the eye image from an enclosure of the rectangular frame, wherein the eye image contains an eye in the face image. In an embodiment, k1=k2.

In accordance with the present invention, the step of said obtaining the eye image from the analyzed image, processed by the processing unit, further includes steps of obtaining a face image from the analyzed image; finding each central point of two nostrils in the face image; calculating a distance D between the central points of the two nostrils and a middle point between the central points of the two nostrils; determining a base point based on the distance D and the middle point; defining a rectangular frame in the face image based on the base point, wherein the base point is at a central point of the rectangular frame; and obtaining the eye image from an enclosure of the rectangular frame, wherein the eye image contains an eye in the face image.

Compared to the prior art, in accordance with the present invention, the eye image or the rectangular frame not only includes an eye but has a smaller area to be searched for than that in the prior art. Besides, in accordance with the present invention, only an upper eyelid in an image is required to be analyzed, and accordingly it is not necessary to spend additional time on analyzing a lower eyelid in the image.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

FIG. 1 is a system block diagram illustrating a drowsiness warning device in accordance with an embodiment of the present invention.

FIGS. 2 and 3 are processing flow charts of a processing unit in accordance with an embodiment of the present invention.

FIG. 4 is a schematic view showing an upper-eyelid image created by the processing unit in accordance with an embodiment of the present invention.

FIG. 5 is a detailed flow chart of the processing unit in accordance with an embodiment of the present invention.

FIG. 6 is a schematic view showing an image 6 captured by an image capturing unit in accordance with an embodiment of the present invention.

### DETAILED DESCRIPTION OF THE INVENTION

Illustrative embodiments accompanying with figures are now described below to lead the characteristics, contents, advantages and effects of the invention to be understood by the Examiner. Figures are illustrated only for explanation, but are not drawn to scale and precise arrangement, and thus the scope of the invention should not be limited by the scale and arrangement illustrated in the figures.

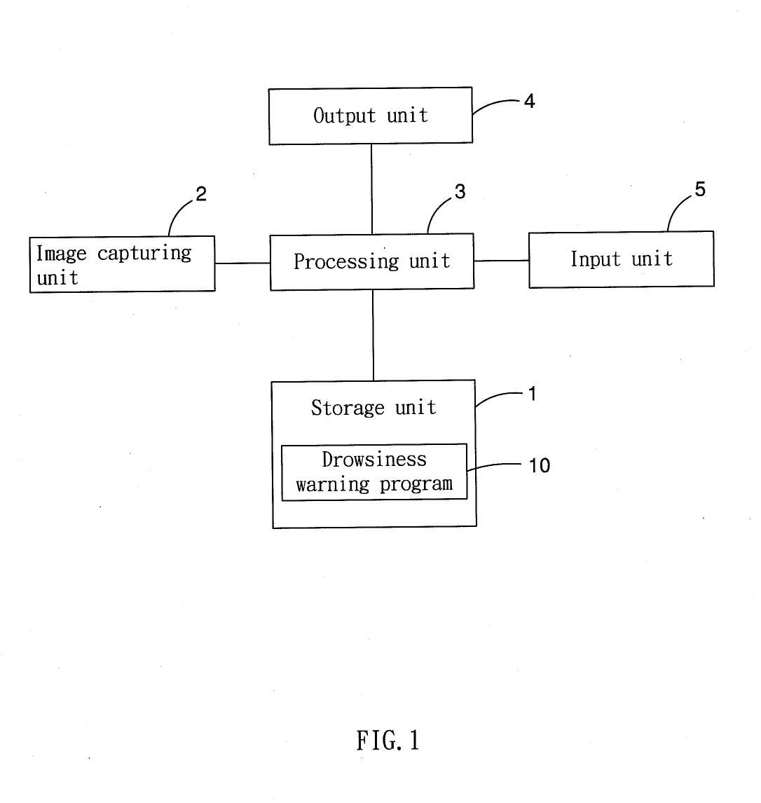

FIG. 1 is a system block diagram illustrating a drowsiness warning device in accordance with an embodiment of the present invention. The drowsiness warning device includes a storage unit 1, an image capturing unit 2, a processing unit 3, an output unit 4 electrically connected to the processing unit 3 and an input unit 5 formed from multiple keys. The storage unit 1 is formed from one or more accessible non-volatile memory devices, and stores a drowsiness warning program 10. The image capturing unit 2 captures a driver's face to generate a sequence of images of the driver's face, and transmits to the images to the storage unit 1 to temporarily store in the storage unit 1.

In an embodiment, the image capturing unit 2 is provided with a lens (not shown) that can be adjusted to turn in directions and orientations so as to point up to the driver's face. For example, the lens can point to the driver's face in an elevation of 45 degrees. Accordingly, each image captured by the image capturing unit 2 can clearly show nostrils, which means nostrils recognition in the each image can be significantly improved. This contributes to a subsequent process of searching for the nostrils. The image capturing unit 2 is further provided with an illumination device for compensating light when light is insufficient. This ensures clarity of captured face images.

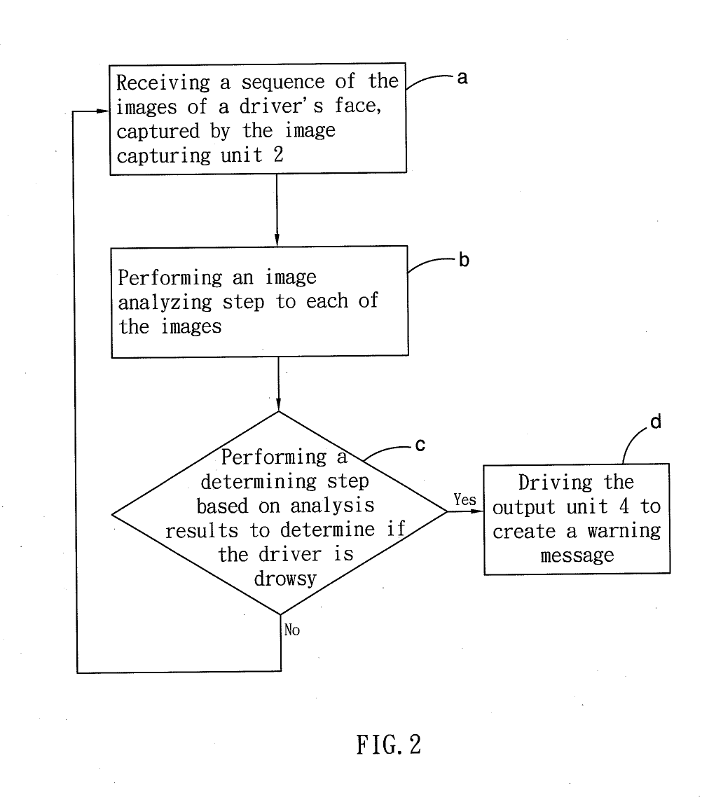

The processing unit 3 is electrically connected to the image capturing unit 2, the storage unit 1 and the output unit 4 and contains a central processing unit (CPU, not shown) and a random access memory (RAM, not shown). The drowsiness warning program 10 when being loaded and processed by the processing unit 3 performs the following steps a-d, as shown in FIG. 2:
a) receiving a sequence of the images of a driver's face captured by the image capturing unit 2;
b) performing an image analyzing step to each of the images;
c) performing a determining step based on analysis results to determine if the driver is drowsy; and
d) driving the output unit 4 to create a warning message if the determining result shows that the driver is drowsy. For example, in the case of the output unit 4 is provided with a speaker, the warning message is an alarm sound created by the speaker. The output unit 4 may be further provided with a display device, such as touch screen, for displaying the warning message or other related information, such as a man-machine interface for setting operation.

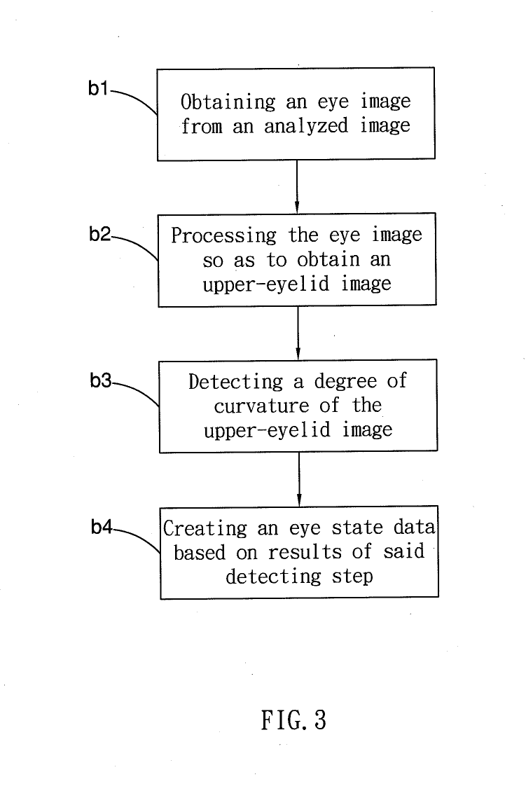

In accordance with the present invention, the step b of performing the image analyzing step, as seen in FIG. 3, includes:
b1) obtaining an eye image from an analyzed image;
b2) processing the eye image so as to obtain an upper-eyelid image;
b3) detecting a degree of curvature of the upper-eyelid image; and
b4) creating an eye state data based on a result of said detecting step.

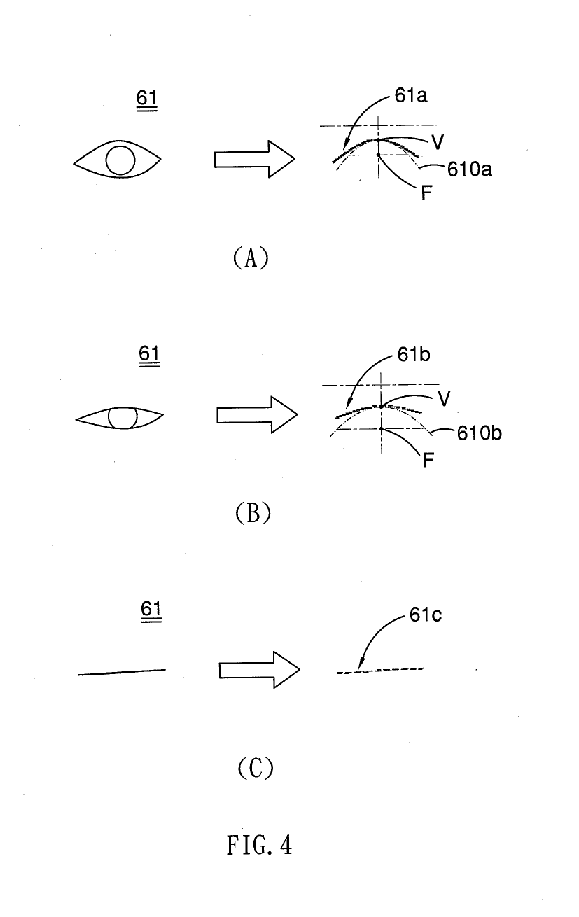

The upper-eyelid image, created after the eye image obtained in the step b1 is processed by using an image processing technology, such as horizontal-linearization process, can be seen in a schematic view of FIG. 4. FIG. 4(A) shows an eye image 61 in an open-eye state and an upper-eyelid image 61a obtained based on the eye image 61. Referring to FIG. 4(A), a parabola 610a can be obtained along the upper-eyelid image 61a and a focal distance of the parabola 610a between the apex V thereof and the focal point F thereof can be calculated based on a parabola formula. FIG. 4(B) shows another eye image 61 in a half-open-eye state and another upper-eyelid image 61b obtained based on the eye image 61. Referring to FIG. 4(B), another parabola 610b can be obtained along the upper-eyelid image 61b and another focal distance of the parabola 610b calculated based on the parabola formula is greater than the focal distance of the parabola 610a. FIG. 4(C) shows another eye image 61 in a close-eye state and another upper-eyelid image 61c obtained based on the eye image 61. Referring to FIG. 4(C), a straight line can be obtained along the upper-eyelid image 61c and a focal distance of the straight line based on the parabola formula is infinite.

Referring to the upper-eyelid images in FIG. 4, a degree of curvature of the upper eyelid varies from a degree of eye opening. According to statistical results, an eye when opening has an upper eyelid with a relatively great degree of curvature, like a parabola. An eye when closing has an upper eyelid with a relatively small degree of curvature, like a straight line. Accordingly, the processing unit 3 can calculate a focal distance of an upper-eyelid image in each eye image 61 based on the parabola formula. Various focal distances represent various degrees of curvature of an upper eyelid, and various degrees of curvature of an upper eyelid represent various state of eye opening. When the processing unit 3 detects the focal distances in a sequence of the processed images gradually increase to infinity from a specific value, the driver's eye captured in the processed images is determined to close and data of “1” representing the close-eye state can be output. When the processing unit 3 detects the focal distances in a sequence of the processed images gradually decrease to a specific value from infinity, the driver's eye captured in the processed images is determined to open and data of “0” representing the open-eye state can be output.

Accordingly, the image capturing unit 2 can capture a sequence of images of the driver's face for a predetermined time, and each of the images can be processed using the above image analyzing step so as to obtain analysis results, that is, data representing the open-eye state or close-eye state. In the other words, the eye state in each of the images can be analyzed and then a determining step to determine if the driver is drowsy can be performed based on the analysis results. For example, in the predetermined number of the images, more than a number N of the continuous images have the analysis results of “1”, which means the driver has closed eyes for a certain time, or the frequency of occurrence of “1” exceeds a threshold, which means the driver closes eyes too often. At this time, the processing unit 3 determines that the driver is drowsy and drives the output unit 4 to create warning messages.

Compared with the prior art that upper-eyelid and lower-eyelid images are required to be analyzed to determine if a driver is drowsy, the present invention analyzing only upper-eyelid images to determine if a driver is drowsy has advantages of readily warning a drowsy driver.

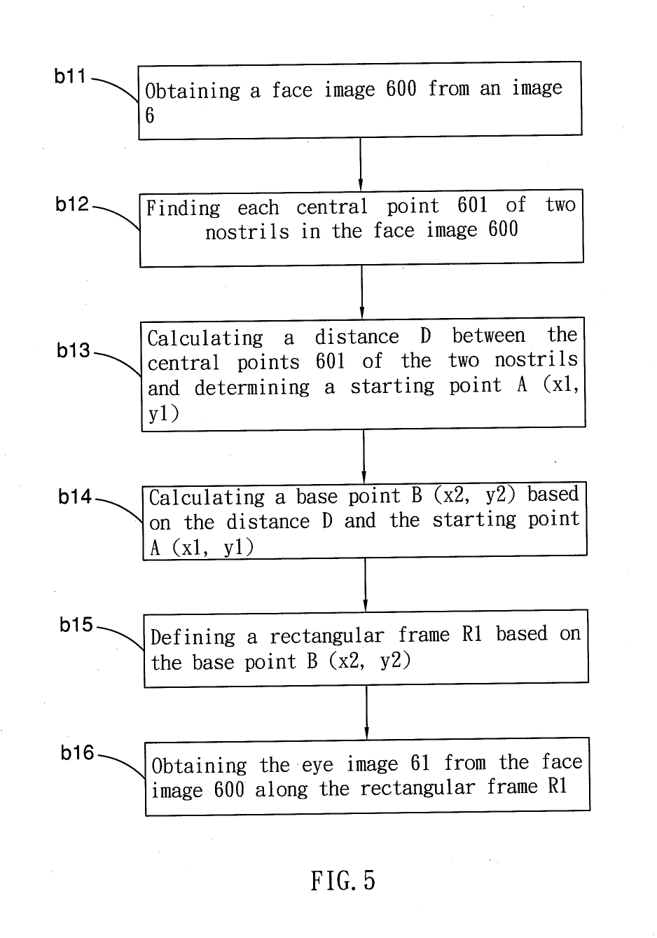

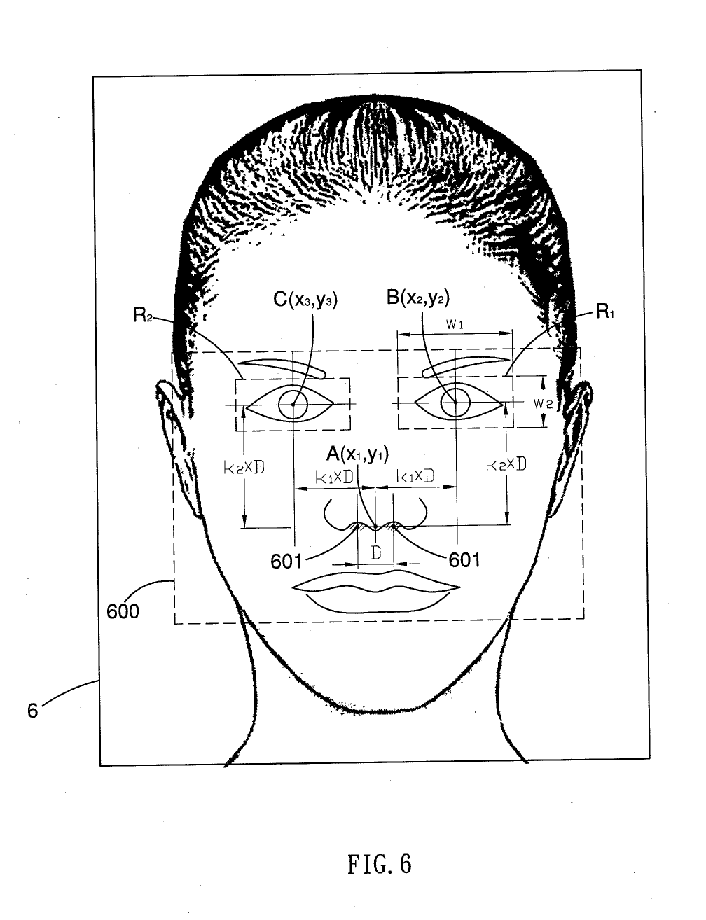

Referring to FIGS. 5 and 6, in accordance with the present invention, the step b1 of obtaining the eye image from the analyzed image further includes the following steps b11-b16:
b11) obtaining a face image 600 from an image 6. The image 6 contains not only the driver's face but a portion to be cut off, wherein the portion to be cut off contains hairs, a neck and a background of the driver. In this step, the face image can be obtained using Adaboost algorithm and some existing image processing technologies. Ideally, the portion to be cut off should be mostly or completely removed from the face image 600.
b12) finding each central point 601 of two nostrils in the face image 600. The method for finding each central point of two nostrils in a face image is described in prior-art references and is not repeated herein. The face image 600 has a region occupied by each nostril, which is a nostril region blacker than other regions. A central point of a nostril can be set at a cross point of the longest lateral and longitudinal axes of the nostril region.
b13) calculating a distance D between the central points 601 of the two nostrils and determining a starting point A (x1, y1) at a middle point between the central points of the two nostrils.
b14) calculating a base point B (x2, y2) based on the distance D and the starting point A (x1, y1), wherein x2=x1+k1×D and y2=y1+k2×D, wherein k1=1.6˜1.8 and k2=1.6˜1.8. In an embodiment, k1=k2. According to results of experiments, the base point B (x2, y2) calculated in the above step can be located at or close to a central point of an eye in the face image. Alternatively, in this step, another base point C (x3, y3) can be calculated based on the distance D and the starting point A (x1, y1), wherein x3=x1−k1×D and y3=y1+k2×D.
b15) defining a rectangular frame R1 in the face image 600 based on the base point B (x2, y2), wherein the base point B (x2, y2) is at a central point of the rectangular frame R1 having a horizontal width w1 between 30 and 50 pixels and a vertical width w2 between 15 and 29 pixels, wherein w1>w2. In an embodiment, w1=40 pixels and w2=25 pixels. Alternatively, another rectangular frame R2 having the same size as the rectangular frame R1 can be determined in the face image 600 based on the base point C (x3, y3), wherein the base point C (x3, y3) is at a central point of the rectangular frame R2.
b16) obtaining the eye image 61 from an enclosure of the rectangular frame R1, as seen in FIG. 4. Alternatively, in this step, another eye image 61 can be obtained from the face image 600 based on the other rectangular frame R2.

According to results of experiments, the rectangular frame R1 determined in the step of b15 just encloses a periphery of an eye in the eye image 600. An eyebrow directly above the eye is not in the rectangular frame R1 or has only a small portion in the rectangular frame R1. A cheekbone directly below the eye is not in the rectangular frame R1 or has only a small portion in the rectangular frame R1. The rectangular frame R2 is in the same situation, too. Accordingly, in the step of b16, each of the eye images can contain an eye, and each of the eye images has a smaller area to be searched for than an eye image of prior art.

According to the above steps of b11-b16, the processing unit 3 performs an eye determining method including the following steps of:
finding each central point of two nostrils in a face image;
calculating a distance D between the central points of the two nostrils and determining a middle point between the central points of the two nostrils;
determining a base point having a horizontal distance to the middle point and a vertical distance to the middle point, wherein the horizontal distance equals k1×D and the vertical distance equals k2×D, wherein k1=1.6˜1.8 and k2=1.6˜1.8, wherein k1=k2 in an embodiment;
defining a rectangular frame in the face image, wherein the base point is at a central point of the rectangular frame having a horizontal width w1 between 30 and 50 pixels and a vertical width w2 between 15 and 29 pixels, wherein w1>w2, wherein w1=40 pixels and w2=25 pixels in an embodiment, wherein the rectangular frame can just enclose a periphery of an eye in the eye image and thereby the processing unit 3 can find an eye from the face image in accordance with the above method of the present invention.

The data, such as face images or eye images, required or created by the processing unit 3 is stored in the storage unit 1. The data is temporarily or permanently stored based on demand.

Compared to the prior art, in accordance with the present invention, the eye image or the rectangular frame not only includes an eye but has a smaller area to be searched for than that in the prior art such that the area to be searched for by the processing unit 3 is relatively small and thus a specific portion, such as the above-mentioned upper eyelid of the eye can be easily and readily found.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A drowsiness warning device comprising a storage unit storing a drowsiness warning program, an image capturing unit capturing a sequence of images of a driver's face, an output unit and a processing unit electrically connected to the image capturing unit, the storage unit and the output unit, wherein the processing unit loads and processes the drowsiness warning program, and the drowsiness warning program enables the processing unit to perform steps comprising:
receiving the images captured by the image capturing unit;
performing an image analyzing step to each of the images, wherein the image analyzing step comprises steps of obtaining an eye image from the image that are analyzed, processing the eye image to obtain an upper-eyelid image, detecting a degree of curvature of the upper-eyelid image and creating an eye state data based on a result of said detecting step;
performing a determining step based on the eye state data to determine if the driver is drowsy; and
driving the output unit to create a warning message if the determining result shows that the driver is drowsy.

2. The drowsiness warning device of claim 1, wherein the step of said obtaining the eye image from the analyzed image, processed by the processing unit, further comprises:
obtaining a face image from the analyzed image;
finding each central point of two nostrils in the face image;
calculating a distance D between the central points of the two nostrils and determining a starting point A (x1, y1) at a middle point between the central points of the two nostrils;
calculating a base point B (x2, y2) based on the distance D and the starting point A (x1, y1), wherein x2=x1+k1×D and y2=y1+k2×D, wherein k1=1.6˜1.8 and k2=1.6˜1.8;
defining a rectangular frame in the face image based on the base point B (x2, y2), wherein the base point B (x2, y2) is at a central point of the rectangular frame having a vertical width and a horizontal width greater than the vertical width; and
obtaining the eye image from an enclosure of the rectangular frame, wherein the eye image contains an eye in the face image.

3. The drowsiness warning device of claim 2, wherein k1=k2.

4. The drowsiness warning device of claim 1, wherein the step of said obtaining the eye image from the analyzed image, processed by the processing unit, further comprises:
obtaining a face image from the analyzed image;
finding each central point of two nostrils in the face image;
calculating a distance D between the central points of the two nostrils and determining a middle point between the central points of the two nostrils;
determining a base point having a horizontal distance to the middle point and a vertical distance to the middle point, wherein the horizontal distance equals k1×D and the vertical distance equals k2×D, wherein k1=1.6˜1.8 and k2=1.6˜1.8;
defining a rectangular frame in the face image based on the base point, wherein the base point is at a central point of the rectangular frame having a vertical width and a horizontal width greater than the vertical width; and
obtaining the eye image from an enclosure of the rectangular frame, wherein the eye image contains an eye in the face image.

5. The drowsiness warning device of claim 4, wherein k1=k2.

6. The drowsiness warning device of claim 1, wherein the step of said obtaining the eye image from the analyzed image, processed by the processing unit, further comprises:
obtaining a face image from the analyzed image;
finding each central point of two nostrils in the face image;
calculating a distance D between the central points of the two nostrils and a middle point between the central points of the two nostrils;
determining a base point based on the distance D and the middle point;
defining a rectangular frame in the face image based on the base point, wherein the base point is at a central point of the rectangular frame; and
obtaining the eye image from an enclosure of the rectangular frame, wherein the eye image contains an eye in the face image.
